(19) United States
(12) Patent Application Publication
(10) Pub. No.: US 2003/0083438 A1
(43) Pub. Date: May 1, 2003

(54) Low MI, amine-modified polyolefins having superior processability and adhesion to ethylene/carbon monoxide copolymers

(76) Inventors: Christian Leboeuf, Kingston, CA (US); Carlton E. Ash, Sugarland, TX (US); Karin Van Poppel, Sugarland, TX (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/163,937

(22) Filed: Jun. 6, 2002

Related U.S. Application Data
(60) Provisional application No. 60/296,157, filed on Jun. 7, 2001.

(51) Int. Cl. C08F 120/02

(52) U.S. Cl. 525/329.7; 525/374; 156/244.22; 428/474.7

(57) ABSTRACT

An adhesive composition is described having an amine-modified, low acid ethylene-methacrylic acid copolymer with a melt flow index (MI) of 1.5 or less. Preferably, the acid copolymer has an acid content between 2 and 5 wt % and an amine content between 0.05 and 0.5 wt %. The adhesive is useful for bonding with an aliphatic polyketone copolymer such as an ethylene-carbon monoxide copolymer.

### CROSS-REFERENCE TO PREVIOUS APPLICATIONS

This application claims priority from U.S. Provisional Application serial No. 60/296,157 filed Jun. 7, 2001, the entire contents of which is incorporated herein by reference.

### FIELD OF THE INVENTION

This invention relates to new adhesives for bonding aliphatic polyketone copolymers to other polymers such as polyolefins, and in particular this invention relates to adhesives having amine-modified ethylene-methacrylic acid copolymers with low melt index.

### BACKGROUND OF THE INVENTION

It is becoming increasingly important to bond different polymers together. Combinations of polymers are commercially important because each polymer provides valuable attributes to the combination. Examples of desirable attributes include barrier and cost, chemical resistance and dimensional stability, and toughness and strength. One example where multi-layer polymeric structures are used is in pipe applications where the barrier properties of one polymer are combined with the mechanical properties of a less expensive polymer.

Most polymer combinations have poor miscibility resulting in blends that are not a single phase. Non-miscible polymers frequently do not generate strong interfacial bonding, which can lead to delamination and the resulting loss of properties. Thus, it is of critical importance to have strong interfacial bonds between the polymeric layers to achieve and maintain the desired properties of the combination.

Aliphatic polyketone copolymers, such as polymers of carbon monoxide and ethylenically unsaturated hydrocarbons are now well known. High molecular weight aliphatic polyketone copolymers have excellent mechanical properties, chemical resistance, and barrier properties, thus making them especially useful to combine with other polymers. Aliphatic polyketone copolymers are disclosed in U.S. Pat. Nos. 4,880,903 and 5,369,170, which are incorporated herein by reference.

U.S. Pat. No. 5,637,410 to Bonner et. al., which is incorporated herein by reference, discloses adhesive blends of carboxylic acid derivative graft polymers and a low-density polyethylene reacted in the presence of a diamine. The preferred graft polymer is a maleic anhydride graft polyethylene. Multi-layer structures made of these blends together with polyketones are also described.

The polymeric compositions described in U.S. Pat. No. 5,369,170 may be produced by a melt blending process. In this type of process, the adhesive is thought to be present as a layer between the aliphatic polyketone copolymer and the polymer to which it is bound. Multi-layer structures such as pipes can also be prepared by co extrusion.

U.S. Pat. No. 5,921,649 to Ash, which is incorporated herein by reference, discloses the use of an amine-modified acid copolymer with low acid content to bond with polyketones. The polyketones are preferably ethylene-carbon monoxide copolymers, an example of which is available from Shell Oil Company under the mark Carilon®. One of the monomer units of the amine-modified acid copolymer is an ethylenically unsaturated carboxylic acid whereas the other monomer units are olefinacally unsaturated hydrocarbons. The acid content is described as low (between 0.015 and 2.04 mole %) and the melt flow index is between 3 and 7. The acid copolymer is modified with a small amount of amine (as little as 0.001 mole %).

The amine-modified acid copolymer of U.S. Pat. No. 5,921,649 generally provides good adhesion to polyketones, however, it has been found that such structures fail cohesively, that is, within the acid copolymer layer rather than at the interface with the polyketone. Moreover, in pipe-making applications where the extrusion speed is relatively low, it has been found that such acid copolymers are very difficult to process. These processability problems occur at the acid copolymer/polyketone interface due to inadvertent mixing and cross-linking of the polyketone and the amine components.

The preparation and use of such multi-layer structures, therefore, can be problematic, especially where extrusion speed is relatively low. There remains a need for an adhesive composition for polyketones that lessens the propensity towards cross linking of the polyketone and the amine components, and alleviates the poor processability in applications where extrusion speed is low.

These problems are addressed by the present invention. Accordingly, it is an object of one aspect of the present invention to provide an adhesive composition useful for bonding with aliphatic polyketone copolymers.

It is another object of another aspect of the present invention to provide a co-extruded multi-layered structure comprising a polyketone, a polyolefin and an adhesive, where the extrusion speed may be low.

### SUMMARY OF THE INVENTION

Accordingly, in one aspect of the present invention, there is provided an adhesive composition comprising an amine-modified, low acid ethylene-methacrylic acid copolymer having a melt flow index (MI) of 1.5 or less.

In a second aspect of the present invention, there is provided a co-extruded multi-layered structure comprising:

(a) an aliphatic polyketone copolymer layer,

(b) a polyolefin layer, and

(c) an adhesive layer comprising an adhesive composition comprising an amine-modified, low acid ethylene-methacrylic acid copolymer having a melt flow index (MI) of 1.5 or less between the aliphatic polyketone copolymer layer and the polyolefin layer.

### DETAILED DESCRIPTION OF THE PREFERRED EMBODIMENTS

The present invention will be described with reference to its preferred embodiments.

Bonding aliphatic polyketone copolymers to polyolefin polymers comprises exploiting the reactive nature of aliphatic ketones towards amines. The result produces imine or pyrrole adducts. By reactively extruding diamines with functional polyolefins, the resulting aminated polyolefins can react with polyketones to efficiently graft and promote adhesion between the polyolefin and the polyketone. It has been found that the best amine to use is a straight chain alkyl or primary diamine. Both anhydride and acid containing polyolefins can be reacted with amines to produce an effective adhesive for polyketones. The amine reaction with the functionalized polyolefin can be either a simple acid/base reaction to form an ammonium salt or can form a covalent bond, e.g. amide or imide. Amine stoichiometry and processing conditions need to be considered when combining the diamine with the functionalized polyolefin.

The above technology is described in the following U.S. Patents, PCT International Patent Applications and a research disclosure made by C. E. Ash and D. H. Weinkauf of Shell Chemicals:

U.S. Pat. No. 4,543,440 to G. L. Loomis (E. I. DuPont)

U.S. Pat. No. 5,369,170 to D. H. Weinkauf (Shell Oil Company)

U.S. Pat. No. 5,599,881 to H. Xie (DuPont Canada)

U.S. Pat. No. 5,637,410 to J. G. Bonner, P. K. G. Hodgson (BP Chemicals)

U.S. Pat. No. 5,753,771 to H. Xie (DuPont Canada Inc.)

International Application No. PCT/GB94/02114 to J. G. Bonner, P. K. G. Hodgson (BP Chemicals)

International Application No. PCT/EP94/04135 to D. H. Weinkauf (Shell Oil Company)

“Bonding Aliphatic Polyketone Polymers to Incompatible Polyolefin Polymers—by Extruding Diamines with Functional Polyolefins and Reacting Resulting Product with Polyketones” by C. E. Ash, D. H. Weinkauf (Shell) in Research Disclosure, January 1997, No. 393

One application where it is becoming increasingly important to have multi-layered polymeric structures is in making pipes. In pipe-making applications, it is desirable to co-extrude a polymer with good barrier properties with a less expensive polymer to provide other physical properties such as strength. Carilon® ethylene-carbon monoxide copolymer has been found to provide excellent barrier properties in these applications, however, its adhesion to polyolefins such as polyethylene and polypropylene is very weak.

U.S. Pat. No. 5,921,649 to Ash discloses the use of low acid, amine-modified acid copolymers as an adhesive for polyketones. This adhesive, however, has been found to cause processability problems in certain commercial pipe-making applications because the extrusion speed is relatively slow. The problems occurred at the interface of the acid copolymer and the polyketone where excessive cross-linking of the polyketone and the amine occurred. One way to reduce excessive cross-linking is to reduce the amount of amine component in the acid copolymer, however, by doing so the adhesion became weak.

The applicants have now found that the difference in viscosity of the polyketone and the acid copolymer creates turbulence during extrusion and contributes to the excessive cross-linking. The applicants have surprisingly found that by reducing the melt flow index of the acid copolymer, thereby increasing its viscosity, the processability problems were reduced or eliminated, while at the same time maintaining excellent adhesion because the amine component did not have to be reduced.

Therefore, the processability problems encountered in slow extrusion applications is addressed by the low MI, low acid copolymers of the present invention.

The low MI amine-modified acid copolymer:

U.S. Pat. No. 5,921,649 describes amine-modified acid copolymers, however, they are limited to such acid copolymers with relatively high melt flow indices (MI). It has been found by the inventors herein that acid copolymers with lower MI, less than 1.5, preferably less than 1.0, surprisingly improve their processability with aliphatic polyketone copolymers.

The amine-modified acid copolymers may be prepared by melt blending an acid copolymer with a suitable diamine. The acid copolymer is a copolymer in which at least one of the monomer units used to make the polymer is an ethylenically unsaturated carboxylic acid. The alpha carbon (with respect to the hydroxycarbonyl group) of the acid monomer is bonded to a functional group and is not directly bonded to a hydrogen atom; polymers made of such compositions are referred to herein as hindered acid copolymers and offer significant advantages in adhesion to polyketones.

Although monocarboxylic acids are preferred monomers for the acid copolymer, the acid monomer may comprise a polycarboxylic acid such as a dicarboxylic acid or a tricarboxylic acid. The other monomer units of the acid copolymer are preferably olefinically unsaturated hydrocarbons such as one or more of the following: ethylene, propylene, butene-1, styrene, methyl(meth)acrylate, and vinyl acetate. Random copolymers of ethylene or propylene and R—CR₁ CO₂ H, wherein R is a C₁₋₁₀ olefinically unsaturated hydrocarbon and R₁ is a C₁₋₆ alkyl group are the preferred acid copolymers of this invention with random poly(ethylene-methacrylic acid) and random poly(propylene-methacrylic) acid being the most preferred acid copolymers (particularly where the optional second polymer comprises polyethylene or polypropylene respectively).

The acid content of the acid copolymer is low. In the preferred embodiment in which the acid copolymer is an ethylene-methacrylic acid copolymer, the acid content is, 0.015-2.04 mole % acid. Preferably, the acid content comprises 0.34-1.73 mole % and more preferably, 1.15-1.55 mole %. All references to mole % acid content herein are based on a calculation of the number of moles of the acid monomer relative to the total number of moles of all monomer units forming the polymer. Alternatively, a low molar content of acid (qualifying as low acid copolymer) can be attained by intermixing various quantities of acid copolymer such that the mole % acid content is in accord with the foregoing percentages based on the total acid content for the acid copolymer blend.

The melt flow index (MI) of the amine-modified acid copolymer is no more than 1.5 g/10 min (based on ASTM D1238, which is performed at 190° C. using a weight of 2.16 Kg.). Melt flow indices of less than 1.0 are preferred, and of 0.3 to 1.0 are most preferred.

The weight average molecular weight of the acid copolymer is 2000-1,000,000 as determined by gel permeation chromatography. The crystalline melting point of the acid copolymer is 80-300° C. (as measured by DSC) with 80-220° C. being preferred. If the acid copolymer does not have a crystalline melting point, its glass transition temperature is −80 to 200° C. (as measured by DSC). These parameters are preferably met through the use of ethylene-methacrylic acid copolymers available and having an acid content of about 4 wt % and a melt flow index (MI) of no more than 1.5.

The amine component of the amine modified hindered acid copolymer has at least two amine functional groups and is of the form NH₂—R—NH₂ wherein R comprises C₄₋₂₄ substituted or unsubstituted aliphatic, cycloaliphatic, or aromatic groups or combinations thereof and may contain hetero atoms such as S, N, and O. Depending upon the composition of R, more than two amino groups may be present in the amine of this invention. It is most preferred that the amine component is an unhindered primary diamine. For the purposes of this specification, an unhindered amine component is of the form above wherein the carbon atoms, to which each amine group is attached, carries two hydrogen atoms. A few examples of suitable amines are 4,9-dioxa-1,12-dodecane diamine; 1,4-diaminobutane; 1,10-diaminodecane; 4,4′-diaminodiphenyl ether; 1,12-diaminododecane; 1,7-diaminoheptane; 1,6-diaminohexane; 1,3-diamino-2-hydroxypropane; 2,3-diaminonapthalene; 1,8-diaminooctane; 1,5-diaminopentane; 1,3-diaminopropane; 1,3-diamino-2-propanol; and 1,4-diamino-2-butanone. It is possible to use the amine in a wholly or partly neutralized form, i.e. as a salt of an acid. One or more amines can be used in combination. Additionally, the amine component can be a reagent that produces an amine of the type described above upon further chemical reaction such as hydrolysis. For example, imine reagents that produce amines upon contact with water can also be used to prepare the amine modified acid copolymers used in this invention.

An effective amount of amine is used to achieve the desired level of adhesion. The quantity of amine is preferably low. While a stoichiometric excess of acid copolymer can be used it is a particular advantage of this invention that as little as 0.05 to 0.5 wt %, preferably 0.1 to 0.2 wt % amine (in the acid copolymer) can be used with good effect in some applications. One of ordinary skill in the art will recognize applications in which greater amounts of adhesion are required and will increase the relative proportion of amine accordingly. However, maximum adhesion is generally attained through the addition of at least 20× less than the stoichiometric quantity of diamine.

The amine-modified acid copolymer of this invention may be made by melt blending the acid copolymer with the amine by any suitable means, for example via extruder or Brabender mixer. Suitable temperatures for melt blending are at least 15° C. above the Tₘₑₗₜ of the acid copolymer, typically above 120° C., but generally below 300° C. A preferred temperature range is 150-280° C. If desirable, the preparation of the amine-modified acid copolymer may be effected simultaneously with a melt processing step that is carried out when preparing the multi-layer structure of this invention as set forth below. It is also possible to perform the reaction between the amine and acid copolymer by heating the reactants dissolved in a suitable solvent, for example, p-xylene, diethyleneglycol dimethylether and triethylene glycol dimethylether.

The aliphatic polyketone copolymers:

The aliphatic polyketone copolymers useful in this invention are of an alternating structure and contain substantially one molecule of carbon monoxide for each molecule of ethylenically unsaturated hydrocarbon. The portions of the polymer attributable to CO alternate with those attributable to the ethylenically unsaturated hydrocarbon.

It is possible to employ a number of different ethylenically unsaturated hydrocarbons as monomers within the same polymer but the preferred polyketone copolymers are copolymers of carbon monoxide and ethylene or terpolymers of carbon monoxide, ethylene and a second ethylenically unsaturated hydrocarbon of at least 3 carbon atoms, particularly an α-olefin such as propylene. Additional monomers can also be used and still come within the scope of polyketone copolymers described herein. That is, polyketone copolymers can be made from four, five, or more combinations of monomers. Such polyketone copolymers are aliphatic in that there is an absence of aromatic groups along the polymer backbone. However, alternating polyketones may have aromatic groups substituted or added to side chains and yet still be considered alternating aliphatic polyketones.

When the preferred polyketone terpolymers are employed, there will be within the terpolymer at least about 2 units incorporating a moiety of ethylene for each unit incorporating a moiety of the second or subsequent hydrocarbon. Preferably, there will be from about 10 units to about 100 units incorporating a moiety of the second hydrocarbon. The polymer chain of the preferred polyketone polymers is therefore represented by the repeating formula:

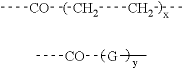

where G is the moiety of ethylenically unsaturated hydrocarbon of at least three carbon atoms polymerized through the ethylenic unsaturation and the ratio of y:x is no more than about 0.5. When copolymers of carbon monoxide and ethylene are employed in the compositions of the invention, there will be no second hydrocarbon present and the copolymers are represented by the above formula wherein y is zero. When y is other than zero, i.e. terpolymers are employed, the —CO—(—CH₂—CH₂—)— units and the —CO—(—G)— units are found randomly throughout the polymer chain, and preferred ratios of y:x are from about 0.01 to about 0.1. The precise nature of the end groups does not appear to influence the properties of the polymer to any considerable extent so that the polymers are fairly represented by the formula for the polymer chains as depicted above.

Of particular interest are the polyketone polymers of number average molecular weight from about 1000 to about 200,000, particularly those of number average molecular weight from about 20,000 to about 90,000 as determined by gel permeation chromatography. The physical properties of the polymer will depend in part upon the molecular weight, whether the polymer is a copolymer or a terpolymer, and in the case of terpolymers the nature of the proportion of the second hydrocarbon present. Typical melting points for the polymers are from about 175° C. to about 300° C., more typically from about 210° C. to about 270° C. The polymers have a limiting viscosity number (LVN), measured in m-cresol at 60° C. in a standard capillary viscosity measuring device, of from about 0.5 dl/g to about 10 dl/g, more frequently of from about 0.8 dl/g to about 4 dl/g. The backbone chemistry of aliphatic polyketones precludes chain scission by hydrolysis. As a result, they generally exhibit long-term maintenance of their property set in a wide variety of environments.

The production of polyketone polymers is described in U.S. Pat. Nos. 4,808,699 and 4,868,282 to van Broekhoven, et al which issued on Feb. 28, 1989 and Sep. 19, 1989 respectively, and are herein incorporated by reference. U.S. Pat. No. 4,808,699 teaches the production of linear alternating polymers by contacting ethylenically unsaturated compounds and carbon monoxide in the presence of a catalyst comprising a Group VIII metal compound, an anion of a nonhydrohalogenic acid with a pKa less than 6 and a bidentate phosphorous, arsenic or antimony ligand. U.S. Pat. No. 4,868,282 teaches the production of linear alternating terpolymers by contacting carbon monoxide and ethylene in the presence of one or more hydrocarbons having an ethylenically unsaturated group with a similar catalyst.

A preferred aliphatic polyketone copolymer is an ethylene-carbon monoxide copolymer available from Shell Oil Company as Carilon®.

The optional, second polymer may be an addition polymer or a condensation polymer. Where an addition polymer is used, preferably it is a polymer of one or more olefinically unsaturated compounds (i.e., a compound having carbon-carbon double bonds) polymerized through their olefinic unsaturation (or as a result of a rearrangement of the unsaturation during polymerization); for example, ethylene, propylene, butene-1, styrene, methyl(meth)acrylate, vinyl acetate or combinations thereof. Preferably the polymer is comprised of C₁₋₁₀ olefinically unsaturated hydrocarbon monomers; the well-known polyolefins such as polyethylene, polypropylene, poly(butene-1) and polystyrene are preferred among this group. High-density polyethylene (HDPE), (i.e., having a density greater than 930 kg/m³) is desirable. Low density polyethylene and linear low density polyethylene (i.e., having a density less than 930 kg/m³) are also suitable. Isotactic polypropylene is the preferred polypropylene. Condensation polymers include, for example, polyamides such as polyamide-6, polyamide-6,6, polyamide-11 and polyamide-12, and poly(phenylene oxide). Another class of polymers useful as the second polymer of this invention is functionalized polymers wherein the functionality is reactive with amine component. Acid copolymers and derivatives thereof such as maleated polypropylene, maleated styrene, and maleated polybutylene are examples of such second polymers.

The weight average molecular weight of the second polymer is in the range of 2,000-1,000,000, preferably 10,000-500,000, as determined by gel permeation chromatography. The crystalline melting point is about 80° C. to about 300° C., as measured by DSC, or, if the second polymer does not possess a crystalline melting point, its glass transition temperature is about −80 to about 200° C., as measured by DSC.

If the optional second polymer is present, the amine-modified acid copolymer preferably has good compatibility with the second polymer. For example, if the second polymer is a polyolefin, it would be preferred that the amine modified polymer is a polyolefin which comprises carboxylic acid groups. On the other hand, if the second polymer is a poly(phenylene-oxide), it would be preferred that the amine modified polymer is a polymer such as a polystyrene having hindered carboxylic acid groups.

The multi-layered structures of this invention can be obtained by coextruding the polyketone copolymer and (optionally) a second olefinic polymer with the low MI amine-modified acid copolymer. Reaction of the polyketone copolymer with the low MI amine-modified acid copolymer typically requires temperatures above 100° C. but generally below 300° C.

In one embodiment, the multi-layered structure of this invention is in the form of a blend in which the low MI amine-modified acid copolymer acts as a compatabilizer. Such blends can be made by any melt blending process that affects an intimate blending of the components of the composition. Such processes are well known to those of ordinary skill in the art and include, for example, extrusion and combination in a Brabender mixer. The ratio of polyketone copolymer to the second polyolefin may vary within a broad range, for example between 5/95 and 95/5. Preferably, the range is between 10/90 and 90/10. A range between 20/80 and 80/20 is more preferred. The quantity of the amine-modified acid co polymer will generally relate to the quantity of the polyketone copolymer or of the second polyolefin if used as the minor component. Generally, it will comprise about 1-40 wt % (based on weight of the minor component) with 2-20 wt % being preferred.

In the preferred embodiment, the present invention is a multi-layer structure in which the polyketone copolymer forms a first layer, the second polyolefin forms a second layer, and both layers are bonded together by an intermediate layer of the low MI amine-modified acid copolymer functioning as an adhesive layer. Compositions having four or more layers may also be formed with additional intermediate layers.

Such multi-layer structures can be made, for example, by coextruding a melt of the amine-modified acid copolymer in between the first and second layers which may be heated, e.g., at a temperature above 100° C. but below 270° C. simultaneously or in a later stage, thus effecting interfacial bonding. Other methods such as compression molding and co-injection molding can also be used. The most preferred method of making multi-layer structures is a co extrusion process in which a melt of the amine-modified acid copolymer is extruded between a melt of polyketone and a melt of the second polyolefin. In such a coextrusion process, the three melts are brought together in a suitable multi-layer manifold prior to exiting the die. The manifold is kept at a temperature of at least 150° C., preferably at least 180° C. but, generally less than 300° C. The most preferred range is 200-280° C. In the manifold the temperature is generally the highest of the extrusion temperatures. The total residence time in the manifold can vary from less than one minute to more than ten minutes. It is preferred that polymer having similar melt viscosities at the prevailing conditions be used. Making more extensive multi-layer structures will require more streams of polymer melts be guided into the multi-layer manifold. For example, a composite can be made from a layer of polyethylene followed by a layer of amine-modified acid copolymer, followed by a layer of polyketone regrind, followed by a layer of amine-modified acid copolymer, followed by a layer of polyethylene regrind. Such composites improve the economics of multi-layer constructions by using regrind layers but also permit the manufacturer to recognize the advantages of the properties of polyolefins together with those of polyketones.

The multi-layer structures may be processed further, for example, through regrind, by bending (e.g., tubes, pipes), by stretching (e.g., of sheet to form film) or by thermoforming or blow molding (e.g., to form a container).

In the multi-layer structures of this invention, the thickness of the first and second layer will depend on application driven requirements. For example, the thickness may range from 5-5000 μm, for example, in a film or sheet application, to 0.1-100 mm in tubing and pipe applications. The thickness of the intermediate layer will frequently range from 5-1000 μm.

In another embodiment of this invention, no second layer is present. For example, the low MI amine-modified acid copolymer can be applied directly to a polyketone layer (or vice versa) to be used as a coating. This can be done in any form in which either polymer may take. For example, tubes, pipe, and sheet can all be coated in this way.

In yet another embodiment of this invention, a multi-layer structure is formed in which the amine-modified acid copolymer is used as an adhesive between a layer of polyketone and a layer of another material which is not a thermoplastic polymer, for example glass, metal (such as aluminum or copper), or a thermosetting resin (such as a phenol-formaldehyde or epoxy resin). The considerations and conditions described above wherein a second polymer is used apply to the embodiments in which no second polymer is used. Additionally, successive applications of powder coatings of polyketone and amine-modified acid copolymer can also be used to adhere the combination to the surface of a substrate using well-known powder coating techniques.

The polyketone, second polyolefin, and low MI amine-modified acid copolymer may contain additives such as reinforcing fillers, non-reinforcing fillers, stabilizers, extenders, lubricants, pigments, plasticizers, and other polymeric materials to improve or otherwise alter its properties.

The compositions of this invention display excellent adhesion and an absence of gels, bubbles, or lumps. They also exhibit excellent performance properties such as impact resistance, chemical resistance and barrier properties. Multi-layer structures can be formed with a good thickness of the various layers and do not show delamination in the presence of water or hydrocarbons.

### EXAMPLES

The following examples show that the low MI amine-modified acid copolymers of the present invention present significant surprising advantages in adhesion and processability when used as adhesive in coextrusions with aliphatic polyketone copolymers. Advantages in processability can be highlighted by the quality of the polyketone layer when the extrusion rate of the tie layer is reduced t a minimum, relative to the polyketone layer. Under those circumstances, particularly when there is a significant difference between the melt viscosity of the polyketone and the tie layer material, microturbulence at the interface results in mixing of the polyketone and the adhesive. This produces crosslinking and the appearance of gels, bubbles or lumps in the polyketone layer. Thus the inner surface (polyketone) of the coextruded structure (small diameter tubing or forecourt pipe) becomes very rough and irregular in thickness. This behaviour is also typical of commercial scale extrusion of small diameter piping (forecourt pipe) where the outer HDPE layer and the polyketone inner layer are bonded together by a layer of the adhesives of the invention. Under such coexrusion conditions, matching of the melt viscosity of the adhesive material with that of the other 2 adjacent layers becomes critical for good processability and for acceptable physical appearance of the inner polyketone layer.

Both 3-layer small diameter tubing and forecourt piping coextrusion were used to evaluate the performance of the adhesive compositions of the present invention. In some cases, the peel force required to separate the layers at the polyketone/tie layer interface was measured using an Instron tester (90° T-peel).

The ultimate test to assess adequacy of bond strength between the adhesive layer and the other adjacent layers of the coextruded structure was obtained through a “fuel soak” test. For that purpose, short sectiions of a forecourt pipe, coextruded on a commercial line, were immersed in M15 fuel mixture (unleaded gasoline containing 15% metrhanol) at 50° C. for 1 month. Test pieces were examined at the end of the test period for residual adhesion between the different layers. Data from these various evaluations is summarized in TABLE 1.

### Example 1

An ethylene/methacrylic acid (E/MAA) copolymer (NUCREL® 407 available from DuPont Canada), with 4% MAA component and a melt flow index (MI)=7.0 was extruded on a twin-screw extruder (25 mm Berstorff) with 4,9-dioxa-1,12-dodecane diamine (DODA), added at 0.5% at a Tₘₑₗₜ=110° C.

The resultant amine-modified acid copolymer had a Tₘₑₗₜ=104.5° C., MI=5.9. It was co extruded as a tie layer in a 3-layer tubing construction to bond high-density polyethylene (HDPE) to an ethylene/carbon monoxide (E/CO) copolymer available from Shell Oil Company, called Carilon®. The 3-layer tubing was nominally 0.89 cm OD, had layer thicknesses of 0.48 mm/0.15 mm/0.56 mm for HDPE/Tie Layer/Carilon®, respectively.

Adhesion between the tie layer (amine-modified acid copolymer) and the E/CO copolymer was determined using an Instron tester to perform a 90° T-peel. The adhesion level between the E/CO copolymer and the amine-modified acid copolymer in this case was measured at 19 lbs/linear inch.

### Example 2

An E/MAA copolymer (NUCREL® 403 available from DuPont Canada), with 4% MAA component and MI=3.0 was extruded on a twin screw extruder (25 mm Berstorff) with 4,9-dioxa-1,12-dodecane diamine (DODA), added at 0.50% at a Tₘₑₗₜ=177° C.

The resultant amine-modified acid copolymer had a Tₘₑₗₜ=105° C., MI=2.2. It was co extruded as a tie layer in a 3-layer tubing construction to bond high density polyethylene (HDPE) to a Carilon® ethylene/carbon monoxide (E/CO) copolymer. The 3-layer tubing was nominally 0.89 cm OD, had layer thicknesses of 0.58 mm/0.13 mm/0.56 mm for HDPE/Tie Layer/Carilon®, respectively.

Adhesion between the tie layer (amine-modified acid copolymer) and the E/CO copolymer was determined using an Instron tester to perform a 90° T-peel. The adhesion level between the E/CO and the amine-modified polyolefin in this case was measured at 38 lbs/linear inch.

### Example 3

An E/MAA copolymer (NUCREL® 403 available from DuPont Canada), with 4% MAA and MI=3.0 was extruded on a twin screw extruder (25 mm Berstorff) with 4,9-dioxa-1,12-dodecane diamine (DODA), added at 0.40% at a Tₘₑₗₜ=245° C.

The resultant amine-modified acid copolymer had a Tₘₑₗₜ=105.3° C. and MI =2.6. It was co extruded as a tie layer in a 3-layer tubing construction to bond high density polyethylene (HDPE) to a Carilon® ethylene/carbon monoxide (E/CO) copolymer. The 3-layer tubing was nominally 0.89 cm OD, had layer thicknesses of 0.79 mm/0.33 mm/0.64 mm for HDPE/Tie Layer/Carilon®, respectively.

Adhesion between the tie layer and the E/CO copolymer was determined using an Instron tester to perform a 90° T-peel. The adhesion level between the E/CO and the amine-modified polyolefin in this case was measured at 33 lbs/linear inch.

### Example 4

An E/MAA copolymer with 4% MAA and MI=1.24 was extruded on a twin screw extruder (25 mm Berstorff) with 4,9-dioxa-1,12-dodecane diamine (DODA) added at 0.15%, at a Tₘₑₗₜ=265° C.

The resultant amine-modified acid copolymer had a Tₘₑₗₜ=104.5° C. and MI =0.83. It was coextruded as a tie layer in a 3-layer construction to bond high density polyethylene (HDPE) to a Carilon® ethylene/carbon monoxide copolymer. The 3-layer tubing was nominally 0.89 cm O.D., had layer thicknesses of 0.36 mm/0.10 mm/0.36 mm for HDPE/tie layer/Carilon® respectively.

Adhesion between the tie layer and the E/CO copolymer was determined using an Instron tester to perform a 90° T-peel. The adhesion between the E/CO and the amine-modified polyolefin in this case was measured at 16 lbs/linear in.

### Example 5

An E/MAA copolymer with 4% MAA and MI=1.50 was extruded on a twin screw extruder (25 mm Berstorff) with 4,9-dioxa-1,12-dodecane diamine (DODA) added at 0.15%, at a Tₘₑₗₜ=262° C.

The resultant amine-modified acid copolymer had a Tₘₑₗₜ=104.5° C. and MI =1.10. It was coextruded as a tie layer in a 3-layer construction to bond high density polyethylene (HDPE) to a Carilon® ethylene/carbon monoxide copolymer. The 3-layer tubing was nominally 0.89 cm O.D., had layer thicknesses of 0.36 mm/0.10 mm/0.36 mm for HDPE/tie layer/Carilon® respectively.

Adhesion between the tie layer and the E/CO copolymer was determined using an Instron tester to perform a 90° T-peel. The adhesion between the E/CO and the amine-modified polyolefin in this case was measured at 20 lbs/linear in.

### Example 6

An E/MAA copolymer with 4% MAA and MI=2.20 was extruded on a twin screw extruder (25 mm Berstorff) with 4,9-dioxa-1,12-dodecane diamine (DODA) added at 0.15%, at a Tₘₑₗₜ=258° C.

The resultant amine-modified acid copolymer had a Tₘₑₗₜ=104.5° C. and MI =1.80. It was coextruded as a tie layer in a 3-layer construction to bond high density polyethylene (HDPE) to a Carilon® ethylene/carbon monoxide copolymer. The 3-layer tubing was nominally 0.89 cm O.D., had layer thicknesses of 0.36 mm/0.10 mm/0.36 mm for HDPE/tie layer/Carilon® respectively.

Adhesion between the tie layer and the E/CO copolymer was determined using an Instron tester to perform a 90° T-peel. The adhesion between the E/CO and the amine-modified polyolefin in this case was measured at 15 lbs/linear in.

### Example 7

A mixture consisting of 28% NUCREL 903 (E/MAA copolymer at 9% MAA, MI=3) and 72% SCLAIR 11L1 (LLDPE, MI=0.72) was extruded on a twin screw extruder (25 mm Berstorff) with 4,9-dioxa-1,12-dodecane diamine (DODA) added at 0.40%, at a Tₘₑₗₜ=281° C.

The resultant amine-modified acid copolymer had a Tₘₑₗₜ=104° C. and MI=0.61. It was coextruded as a tie layer in a 3-layer construction to bond high density polyethylene (HDPE) to a Carilon® ethylene/carbon monoxide copolymer. The 3-layer tubing was nominally 0.89 cm O.D., had layer thicknesses of 0.36 mm/0.10 mm/0.36 mm for HDPE/tie layer/Carilon® respectively.

Adhesion between the tie layer and the E/CO copolymer was determined using an Instron tester to perform a 90° T-peel. The adhesion between the E/CO and the amine-modified polyolefin in this case was measured at 8.1 lbs/linear in.

### Example 8

Same product as example 3.

### Example 9

An E/MAA copolymer with 4% MAA and MI=0.80 was extruded on a twin screw extruder (25 mm Berstorff) with 4,9-dioxa-1,12-dodecane diamine (DODA) added at 0.40%, at a Tₘₑₗₜ=258° C.

The resultant amine-modified acid copolymer had a Tₘₑₗₜ=105° C. and MI=0.39. It was coextruded as a tie layer in a 3-layer construction to bond high density polyethylene (HDPE) to a Carilon® ethylene/carbon monoxide copolymer. The 3-layer tubing was nominally 0.89 cm O.D., had layer thicknesses of 0.36 mm/0.10 mm/0.36 mm for HDPE/tie layer/Carilon® respectively.

Adhesion between the tie layer and the E/CO copolymer was determined using an Instron tester to perform a 90° T-peel. The adhesion between the E/CO and the amine-modified polyolefin in this case was measured at 28.8 lbs/linear in.

### Example 10

An E/MAA copolymer with 4% MAA and MI=0.80 was extruded on a twin screw extruder (25 mm Berstorff) with 4,9-dioxa-1,12-dodecane diamine (DODA) added at 0.25%, at a Tₘₑₗₜ=260° C.

The resultant amine-modified acid copolymer had a Tₘₑₗₜ=104.7° C. and MI =0.51. It was coextruded as a tie layer in a 3-layer construction to bond high density polyethylene (HDPE) to a Carilon® ethylene/carbon monoxide copolymer. The 3-layer tubing was nominally 0.89 cm O.D., had layer thicknesses of 0.36 mm/0.10 mm/0.36 mm for HDPE/tie layer/Carilon® respectively.

Adhesion between the tie layer and the E/CO copolymer was determined using an Instron tester to perform a 90° T-peel. The adhesion between the E/CO and the amine-modified polyolefin in this case was measured at 18.7 lbs/linear in.

### Example 11

An E/MAA copolymer, with 4% MAA and MI=1.0 was extruded on a twin screw extruder (25 mm Berstorff) with 4,9-dioxa-1,12-dodecane diamine (DODA), added at 0.15% at a Tₘₑₗₜ=258° C.

The resultant amine-modified acid copolymer had a Tₘₑₗₜ=104.5° C. and an MI=0.5. It was co extruded as a tie layer in a 3-layer tubing construction to bond high density polyethylene (HDPE) to a Carilon® ethylene/carbon monoxide (E/CO) copolymer. The 3-layer tubing was nominally 0.89 cm OD, had layer thicknesses of 1 mm/0.41 mm/1.02 mm for HDPE/Tie Layer/Carilon®, respectively.

Adhesion between the tie layer and the E/CO copolymer was determined using an Instron tester to perform a 90° T-peel. The adhesion level between the E/CO and the amine-modified polyolefin in this case was measured at 62 lbs/linear inch.

### Example 12

A mixture consisting of 50 wt % of an E/MAA copolymer at 4% MAA, MI=0.51 and 50wt % of NUCREL 403 (E/MAA copolymer at 4% MAA and MI=3.0) dry blended and its resultant 4,9-dioxa-1,12-dodecane diamine (DODA) level and MI were calculated respectively as 0.125% and 1.24 g/10 min.

The resultant amine-modified acid copolymer dry blend was coextruded as a tie layer in a 3-layer commercial construction to bond high density polyethylene (HDPE) to a Carilon® ethylene/carbon monoxide copolymer. The 3-layer tubing was nominally 50 mm O.D., had layer thicknesses of 4 mm/0.12-0.17 mm/2 mm for HDPE/tie layer/Carilon® respectively.

### Example 13

A mixture consisting of 61 wt % of an E/MAA copolymer at 4% MAA, MI=0.51 and 39wt % of NUCREL 403 (E/MAA copolymer at 4% MAA and MI=3.0) was dry-blended and its resultant 4,9-dioxa-1,12-dodecane diamine (DODA) level and MI calculated respectively as 0.153% and 1.02 g/10 min.

The resultant amine-modified acid copolymer dry-blend was coextruded as a tie layer in a 3-layer commercial construction to bond high density polyethylene (HDPE) to a Carilon® ethylene/carbon monoxide copolymer. The 3-layer tubing was nominally 50 mm O.D., had layer thicknesses of 4 mm/0.12-0.17 mm/2 mm for HDPE/tie layer/Carilon® respectively.

### Example 14

A mixture consisting of 50 wt % of an E/MAA copolymer at 4% MAA, MI=0.39 and 50 wt % of NUCREL 403 (E/MAA copolymer at 4% MAA and MI=3.0) was dry-blended and its resultant 4,9-dioxa-1,12-dodecane diamine (DODA) level and MI were calculated respectively as 0.20% and 1.08 g/10 min.

Thus, the resultant amine-modified acid copolymer dryblend was coextruded as a tie layer in a 3-layer commercial construction to bond high density polyethylene (HDPE) to a Carilon® ethylene/carbon monoxide copolymer. The 3-layer tubing was nominally 50 mm O.D., had layer thicknesses of of approximately 4 mm/0.12-0.17 mm/2 mm for HDPE/tie layer/Carilon® respectively.

### Example 15

A mixture consisting of 34 wt % of an E/MAA copolymer at 4% MAA, MI=0.39 and 66 wt % of NUCREL 403 (E/MAA copolymer at 4% MAA and MI=3.0) dry blended and its resultant 4,9-dioxa-1,12-dodecane diamine (DODA) level and MI were calculated respectively as 0.13% and 1.50 g/10/min.

The resultant amine-modified acid copolymer dry blend was coextruded as a tie layer in a 3-layer commercial construction to bond high density polyethylene (HDPE) to a Carilon® ethylene/carbon monoxide copolymer. The 3-layer tubing was nominally 50 mm O.D., had layer thicknesses of approximately 4 mm/0.12-0.17 mm/2 mm for HDPE/tie layer/Carilon® respectively.

### SUMMARY OF EXAMPLES

TABLE 1

| | | | | | | | | PROCESSABILITY | | | |
|---|---|---|---|---|---|---|---|---|---|---|---|
| Examp. | ADHESIVE | | | LAYER THICKNESS | | | ADHES. | TUBING LINE | TUBING LINE | | FUEL SOAK |
| # | % MAA | MI | % DODA | HDPE | TIE | PK⁽¹⁾ | (pli) | (Low Rate) | (High Rate) | PLANT | TEST |
| 1 | 4 | 5.9 | 0.5 | 19 | 6 | 22 | 19 | — | GOOD | — | |
| 2 | 4 | 2.2 | 0.5 | 23 | 5 | 22 | 38 | — | GOOD | — | |
| 3 | 4 | 2.6 | 0.4 | 31 | 13 | 25 | 33 | POOR | GOOD | POOR | |
| 4 | 4 | 0.83 | 0.15 | 17 | 4 | 17 | 16 | GOOD | GOOD | — | |
| 5 | 4 | 1.10 | 0.15 | 17 | 4 | 17 | 20 | GOOD | GOOD | — | |
| 6 | 4 | 1.80 | 0.15 | 17 | 4 | 17 | 15 | GOOD | GOOD | — | |
| 7 | 4 | 0.61 | 0.4 | 17 | 4 | 17 | 8 | — | GOOD | — | |
| 8 | 4 | 3.0 | 0.4 | 17 | 4 | 17 | 18 | POOR | GOOD | POOR | |
| 9 | 4 | 0.39 | 0.4 | 17 | 4 | 17 | 29 | — | — | POOR | |
| 10 | 4 | 1.24 | 0.125 | — | — | — | — | — | — | GOOD | PASS |
| 11 | 4 | 1.02 | 0.153 | — | — | — | — | — | — | GOOD | PASS |
| 12 | 4 | 1.50 | 0.130 | — | — | — | — | — | — | GOOD | FAILED |
| 13 | 4 | 0.5 | 0.15 | 39 | 16 | 40 | 62 | — | — | V. | PASS |
| | | | | | | | | | | GOOD | |
| 14 | 4 | 1.0 | 0.15 | 41 | 26 | 47 | 53 | — | — | V. | PASS |
| | | | | | | | | | | GOOD | |
| 15 | 4 | 0.51 | 0.25 | 17 | 4 | 17 | 19 | — | GOOD | POOR | |

Although the present invention has been shown and described with respect to its preferred embodiments, it will be understood by those skilled in the art that other changes, modifications, additions and omissions may be made without departing from the substance and the scope of the present invention as defined by the attached claims.

What is claimed is:

1. An adhesive composition comprising an amine-modified, low acid ethylene-methacrylic acid copolymer having a melt flow index (MI) of 1.5 or less.

2. The adhesive of claim 1, wherein the acid copolymer has an acid content in the range of 2 to 5 wt %.

3. The adhesive of claim 2, wherein the acid content is about 4 wt %.

4. The adhesive of claim 1, wherein the acid copolymer has an amine content in the range of 0.05 to 0.5 wt %.

5. The adhesive of claim 4, wherein the amine content is in the range of 0.1 to 0.2 wt %.

6. The adhesive of claim 1, wherein the starting acid copolymer has a viscosity in the range of 0.4 to 2.0 g/10/min.

7. The adhesive of claim 1, wherein the acid copolymer is modified with a primary diamine.

8. The adhesive of claim 7, wherein the primary diamine is 4,9-dioxa-1,12-dodecane diamine.

9. A co-extruded polymeric composition comprising an aliphatic polyketone copolymer and the adhesive composition of claim 1.

10. A co-extruded polymeric composition comprising an aliphatic polyketone copolymer and the adhesive composition of claim 2.

11. A co-extruded polymeric composition comprising an aliphatic polyketone copolymer and the adhesive composition of claim 4.

12. A co-extruded polymeric composition comprising an aliphatic polyketone copolymer and the adhesive composition of claim 7.

13. A co-extruded polymeric composition of claim 9 wherein the aliphatic polyketone copolymer is an ethylene-carbon monoxide copolymer.

14. A co-extruded multi-layered structure comprising:
(a) an aliphatic polyketone copolymer layer,
(b) a polyolefin layer, and
(c) an adhesive layer comprising the adhesive composition of claim 1 between the aliphatic polyketone copolymer layer and the polyolefin layer.

15. The co-extruded multi-layered structure of claim 14 wherein the adhesive layer comprises the adhesive composition of claim 2.

16. The co-extruded multi-layered structure of claim 14 wherein the adhesive layer comprises the adhesive composition of claim 4.

17. The co-extruded multi-layered structure of claim 14 wherein the adhesive layer comprises the adhesive composition of claim 7.

18. The co-extruded multi-layered structure of claim 14 wherein the aliphatic polyketone copolymer layer is an ethylene-carbon monoxide copolymer and the polyolefin layer is a high density polyethylene.
